(19) United States
(12) Patent Application Publication
(10) Pub. No.: US 2025/0252540 A1
(43) Pub. Date: Aug. 7, 2025

(54) IMAGE PROCESSING APPARATUS, IMAGE CAPTURING APPARATUS, AND IMAGE PROCESSING METHOD

(71) Applicant: CANON KABUSHIKI KAISHA, Tokyo (JP)

(72) Inventor: YUSUKE KAWAI, Kanagawa (JP)

(21) Appl. No.: 19/019,807

(22) Filed: Jan. 14, 2025

(30) Foreign Application Priority Data
Feb. 2, 2024 (JP) 2024-015050

(51) Int. Cl. G06T 5/70; G06T 5/50

(52) U.S. Cl. CPC G06T 5/70; G06T 5/50; G06T 2207/20024; G06T 2207/20221; G06T 2207/20224

(57) ABSTRACT

A first obtaining unit obtains a plurality of shot images shot at a plurality of shooting positions positioned such that a spacing between adjacent ones, in a first direction or a second direction orthogonal to the first direction, of the shooting positions is a non-integral multiple of a pixel pitch of an image sensor. A generating unit generates a high-resolution image having a resolution higher than a resolution of the plurality of shot images by performing compositing processing on the plurality of shot images. A filter unit applies, to the high-resolution image, a filter that reduces a high-frequency component produced by the compositing processing. A second obtaining unit performs processing for obtaining a difference between the high-resolution image to which the filter has been applied and one shot image among the plurality of shot images.

### BACKGROUND OF THE INVENTION

### Field of the Invention

The present invention relates to an image processing apparatus, an image capturing apparatus, and an image processing method.

### Description of the Related Art

A technique is known in which, in a digital camera in which the position of the image sensor can be changed, an image having a resolution exceeding the number of pixels of the image sensor (a high-resolution image) can be generated by compositing a plurality of images shot at shooting positions shifted from each other by distances smaller than the pitch of the pixels (see Japanese Patent Laid-Open No. 2012-226489).

If an object that moves (a moving object) is present among the plurality of images to be composited, a region will arise in the composite image in which a component derived from an image in which the moving object is present and a component derived from an image in which the moving object is not present are mixed (a moving object region), resulting in an unnatural composite image.

Obtaining a difference between images is generally known as a way to detect a moving object region.

Here, obtaining the difference between the high-resolution image and the original shot image is conceivable as a way to detect the moving object region in the high-resolution image. Generating a high-resolution image using a technique such as that disclosed in Japanese Patent Laid-Open No. 2012-226489 generally produces high-frequency components not present in the original shot image. Accordingly, if the difference between the images is obtained having simply made the high-resolution image and the original shot image the same size, a relatively large difference may be obtained even in regions where the moving object is not actually present. The moving object therefore cannot be detected with high accuracy.

### SUMMARY OF THE INVENTION

Having been achieved in light of the foregoing circumstances, the present invention provides a technique that makes it possible to obtain, from a high-resolution image and an original shot image, a highly-accurate difference that can be used to identify a moving object region in the high-resolution image.

According to a first aspect of the present invention, there is provided an image processing apparatus comprising at least one processor and/or at least one circuit which functions as: a first obtaining unit configured to obtain a plurality of shot images shot at a plurality of shooting positions of an image sensor positioned such that a spacing between adjacent ones, in a first direction or a second direction orthogonal to the first direction, of the shooting positions is a non-integral multiple of a pixel pitch of the image sensor; a generating unit configured to generate a high-resolution image having a resolution higher than a resolution of the plurality of shot images by performing compositing processing on the plurality of shot images; a filter unit configured to apply, to the high-resolution image, a filter that reduces a high-frequency component produced by the compositing processing; and a second obtaining unit configured to perform processing for obtaining a difference between the high-resolution image to which the filter has been applied and one shot image among the plurality of shot images.

According to a second aspect of the present invention, there is provided an image capturing apparatus comprising: an image sensor; and at least one processor and/or at least one circuit which functions as: a first obtaining unit configured to obtain a plurality of shot images shot at a plurality of shooting positions of the image sensor positioned such that a spacing between adjacent ones, in a first direction or a second direction orthogonal to the first direction, of the shooting positions is a non-integral multiple of a pixel pitch of the image sensor; a generating unit configured to generate a high-resolution image having a resolution higher than a resolution of the plurality of shot images by performing compositing processing on the plurality of shot images; a filter unit configured to apply, to the high-resolution image, a filter that reduces a high-frequency component produced by the compositing processing; and a second obtaining unit configured to perform processing for obtaining a difference between the high-resolution image to which the filter has been applied and one shot image among the plurality of shot images.

According to a third aspect of the present invention, there is provided an image processing method executed by an image processing apparatus, comprising: obtaining a plurality of shot images shot at a plurality of shooting positions of an image sensor positioned such that a spacing between adjacent ones, in a first direction or a second direction orthogonal to the first direction, of the shooting positions is a non-integral multiple of a pixel pitch of the image sensor; generating a high-resolution image having a resolution higher than a resolution of the plurality of shot images by performing compositing processing on the plurality of shot images; applying, to the high-resolution image, a filter that reduces a high-frequency component produced by the compositing processing; and performing processing for obtaining a difference between the high-resolution image to which the filter has been applied and one shot image among the plurality of shot images.

Further features of the present invention will become apparent from the following description of exemplary embodiments with reference to the attached drawings.

### BRIEF DESCRIPTION OF THE DRAWINGS

FIG. 1 is a block diagram illustrating the configuration of a digital camera 100 (an image capturing apparatus) including an image processing apparatus.

FIG. 2 is a flowchart illustrating high-resolution image generation processing.

FIG. 3 is a conceptual diagram illustrating image sensor movement.

FIG. 4 is a flowchart illustrating details of moving object region map generation processing (step S207).

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

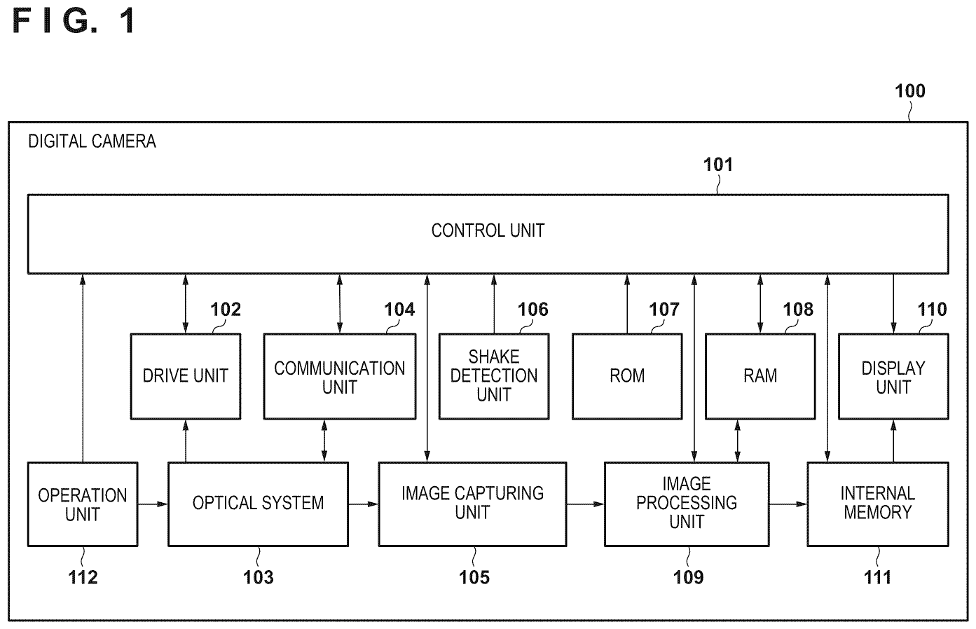

FIG. 1 is a block diagram illustrating the configuration of a digital camera 100 (an image capturing apparatus) including an image processing apparatus. The digital camera 100 is capable of shooting still images. The digital camera 100 is also capable of moving the position of an image sensor included in an image capturing unit 105 in units smaller than a pixel pitch. The digital camera 100 is also capable of recording information on a focus position, calculating a contrast value of an image, and compositing a plurality of images. Furthermore, the digital camera 100 is capable of performing enlargement processing and reducing processing on images which have been shot and stored or images which have been input from the exterior.

Although a digital camera will be used as an example in each embodiment, including the present embodiment, the embodiments are not limited to a digital camera. For example, a mobile device having a built-in image sensor, a network camera capable of capturing images, or the like may be used instead of the digital camera.

A control unit 101 includes a processor such as a CPU, an MPU, or the like, for example, and controls the blocks of the digital camera 100 by reading out and executing programs stored in a ROM 107 in advance. For example, the control unit 101 issues commands to the image capturing unit 105 to start and stop capturing images, as will be described later. The control unit 101 also issues commands for image processing to an image processing unit 109, on the basis of a program stored in the ROM 107. Commands from the user are input to the digital camera 100 through an operation unit 112, and are provided to each block of the digital camera 100 through the control unit 101.

A drive unit 102 includes a motor and the like, and mechanically operates an optical system 103 in response to commands from the control unit 101. For example, the drive unit 102 adjusts a focal length of the optical system 103 by moving the position of a focus lens included in the optical system 103 on the basis of commands from the control unit 101.

The optical system 103 includes a zoom lens, the focus lens, an aperture stop, and the like. The aperture stop is a mechanism that adjusts the amount of light passing therethrough. An in-focus position can be changed by changing the position of the lenses.

A communication unit 104 mainly transmits information between the control unit 101 and the optical system 103 in response to commands from the control unit 101.

The image capturing unit 105 includes an image sensor having photoelectric conversion elements, and performs photoelectric conversion for converting incident light into electrical signals. For example, a CCD sensor, a CMOS sensor, or the like can be used as the image sensor of the image capturing unit 105. The image sensor included in the image capturing unit 105 is configured to be capable of moving in a plane orthogonal to an optical axis of the optical system 103, by predetermined amounts in a horizontal direction, a vertical direction, and clockwise and counterclockwise directions about the optical axis. The control unit 101 can control the position of the image sensor by controlling drive members such as a motor and the like in the drive unit 102. The position of the image sensor is controlled so as to implement an optical image stabilization function, a high-resolution image generation function, and the like. In addition, the image capturing unit 105 can operate in a moving image capturing mode, in which case it is possible to capture a plurality of images that are temporally continuous as respective frames of a moving image.

A shake detection unit 106 detects shaking (vibrations) acting on the digital camera 100. Generally, a gyro sensor that detects the angular velocity of shaking is used as a sensor for detecting shaking.

The ROM 107 is a read-only non-volatile memory serving as a recording medium, and stores parameters and the like necessary for the operations by the blocks of the digital camera 100, in addition to operation programs for those blocks. A RAM 108 is a rewritable volatile memory, and is used as a temporary storage region for data output during the operations of the blocks of the digital camera 100.

The image processing unit 109 performs various types of image processing on images output from the image capturing unit 105 or images recorded in an internal memory 111, such as white balance adjustment, color interpolation, filtering, and the like. The image processing unit 109 also performs compression processing according to a standard such as JPEG or the like on images captured by the image capturing unit 105.

The image processing unit 109 is constituted by an integrated circuit (ASIC) that is a collection circuitry for performing specific processing. Alternatively, the control unit 101 may be configured to handle some or all of the functions of the image processing unit 109 by executing processing according to programs read out from the ROM 107. If the control unit 101 handles all the functions of the image processing unit 109, the digital camera 100 need not include the image processing unit 109 as hardware separate from the control unit 101.

A display unit 110 is a liquid crystal display or an organic EL display, and displays images temporarily stored in the RAM 108, images stored in the internal memory 111, settings screens for the digital camera 100, and the like.

The internal memory 111 is a memory for recording images captured by the image capturing unit 105, images processed by the image processing unit 109, information on the in-focus position when capturing an image, and the like. A memory card or the like may be used instead of the internal memory.

The operation unit 112 includes, for example, buttons, switches, keys, a mode dial, and the like provided in the digital camera 100. The operation unit 112 may also include a touch panel provided on the display unit 110. Commands from the user are provided to the control unit 101 through the operation unit 112.

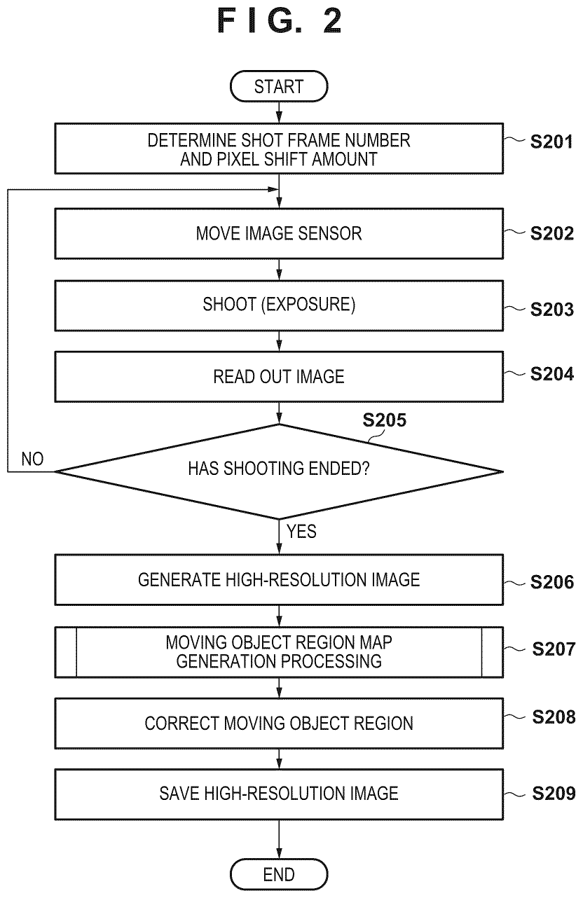

High-resolution image generation processing will be described next with reference to FIG. 2. The high-resolution image generation processing is performed by the image processing unit 109. Note that the high-resolution image generation processing is performed when a shooting mode for generating a high-resolution image (a super-resolution mode) is set, for example. When the super-resolution mode is set, the control unit 101 shoots a plurality of frames of low-resolution images to be used for increasing the resolution. Here, “low-resolution” image means an image having a resolution relatively lower than that of a composite image which will ultimately be generated (that is, the high-resolution image). Accordingly, the low-resolution image may be a still image at the highest resolution the image capturing unit 105 is capable of capturing. The image processing unit 109 generates a high-resolution image for a single frame using a plurality of frames of low-resolution images that have been shot.

In the example illustrated in FIG. 2, the image processing unit 109 generates the high-resolution image following the shooting of the plurality of frames of low-resolution images. However, the image processing unit 109 may temporarily stop the processing after recording the plurality of frames of low-resolution images in the internal memory 111, and then generate the high-resolution image on the basis of the recorded plurality of frames of low-resolution images at a desired timing thereafter.

FIG. 2 is a flowchart illustrating the high-resolution image generation processing. Unless otherwise noted, the processing of each step in this flowchart is performed under the overall control of the control unit 101, performed according to a program. The processing of this flowchart starts when a still image shooting start instruction is detected while the super-resolution mode is set. The still image shooting start instruction may be detected in response to a release switch included in the operation unit 112 being detected as fully-depressed, or may be detected in response to a standby time of a self-timer running out. Note that it is assumed that the control unit 101 has executed processing for determining shooting conditions (aperture value, shutter speed, shooting sensitivity) (that is, AE processing) and automatic focus detection processing (AF processing) for the optical system 103 at the point in time when a shooting preparation instruction is detected before the shooting start instruction has been detected. Note also that the shooting conditions may be values set by the user. The focal distance of the optical system 103 may also be set by the user manually.

In step S201, the control unit 101 determines a shot frame number and a pixel shift amount for the low-resolution images to serve as the source of the high-resolution image. As described above, “low-resolution” image means an image having a resolution relatively lower than that of a composite image which will ultimately be generated (that is, the high-resolution image). Accordingly, the low-resolution image may be a still image at the highest resolution the image capturing unit 105 is capable of capturing.

The shot frame number may be a fixed value set in advance, or may be selectable by the user from a plurality of options. The following descriptions will be given assuming the shot frame number is 4. However, the shot frame number is not limited to 4, and may be any value that is at least 2. Although a higher shot frame number makes it possible to achieve a higher resolution in the high-resolution image, even if the shot frame number is only 2, for example, the high-resolution image can still be generated from the two low-resolution images.

The pixel shift amount for varying the shooting position (viewpoint) can be determined through a variety of methods. For example, the pixel shift amount may be a fixed value, or may be a value based on the shot frame number. It is assumed here that the pixel shift amount is a value lower than the pixel pitch, and the following descriptions will assume that the pixel shift amount is ½ of a pixel (half the pixel pitch). However, the pixel shift amount is not limited to a value lower than the pixel pitch, and any desired value may be used as the pixel shift amount as long as the value is a non-integer multiple of the pixel pitch. The “pixel pitch” is the distance between the centers of adjacent pixels. Although the following descriptions will assume that the pixel pitch is the same in both the horizontal and vertical directions, the pixel pitch may be different in the horizontal and vertical directions. Additionally, the following descriptions will assume that the pixel shift amount in the horizontal and vertical directions is “pixel pitch/2”. However, the pixel shift amount may differ in the horizontal and vertical directions.

The method through which at least one of the shot frame number and the pixel shift amount is determined can change according to the method by which the plurality of frames of low-resolution images are composited to generate one frame of the high-resolution image.

It is assumed here that the digital camera 100 is fixed on a tripod or the like, and that the control unit 101 varies the shooting positions of the low-resolution images by moving the image capturing unit 105 (and more specifically, the image sensor included in the image capturing unit 105). Additionally, although it is assumed here that the control unit 101 shoots the plurality of frames of low-resolution images using a still image continuous shooting function, a moving image having a plurality of frames may be shot and each of the frames in the moving image may be used as a single low-resolution image. When shooting a moving image, the framerate can be determined taking into account the time required to move the image capturing unit 105.

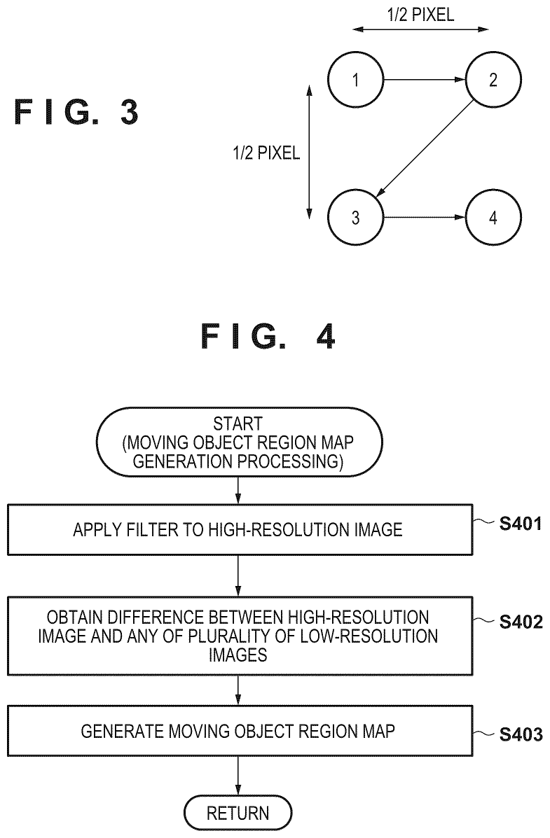

Steps S202 to S205 are processing for shooting the number of frames of low-resolution images determined in step S201. In step S202, the control unit 101 controls the drive unit 102 and moves the image capturing unit 105 (the image sensor) to achieve a pixel shift amount according to the frame. The movement direction of the image capturing unit 105 in each frame is assumed to be predetermined according to the shot frame number. Note that when shooting a base frame (e.g., the first frame), the control unit 101 performs the shooting without moving the image capturing unit 105 from a base position. For example, when shooting a total of four frames, the control unit 101 moves the image capturing unit 105 as illustrated in FIG. 3 when shooting each frame. FIG. 3 illustrates the position of the image capturing unit 105 (the image sensor) as seen from a rear surface side of the digital camera 100 (the opposite side of the digital camera 100 relative to the subject). As can be seen from FIG. 3, the movement amounts of the image capturing unit 105 in the frames, relative to the base position, are as follows.
First frame: no movement (base position)
Second frame: ½ pixel (half the pixel pitch) to the right from the base position
Third frame: ½ pixel downward from the base position
Fourth frame: ½ pixel to the right and ½ pixel downward from the base position

Moving the image capturing unit 105 to a different position for each frame in this manner makes it possible to obtain four frames of low-resolution images from different shooting positions. Once the movement of the image capturing unit 105 is complete, the sequence moves to step S203.

In step S203, the control unit 101 controls the optical system 103 and the image capturing unit 105 to shoot one frame of a still image (expose the image sensor).

In step S204, the control unit 101 reads out an analog image signal from the image capturing unit 105. The read-out analog image signal is input into the image processing unit 109. The image processing unit 109 generates a digital image by performing A/D conversion on the analog image signal, and stores the digital image in the RAM 108 as a low-resolution image after performing various image processing such as development processing as necessary. At this point in time, the image processing unit 109 does not perform processing for increasing the resolution.

In step S205, the control unit 101 determines whether shooting for the number of frames determined in step S201 has ended. If the shooting has ended, the sequence moves to step S206. If the shooting has not ended, the sequence returns to step S202, and the processing of steps S202 to S204 is performed again to shoot the next frame.

In step S206, the image processing unit 109 composites the plurality of low-resolution images stored in the RAM 108 to generate the high-resolution image, by performing processing which uses pixel insertion to increase the resolution, as disclosed in, for example, Japanese Patent Laid-Open No. 2012-226489. Note, however, that the method for generating the high-resolution image is not limited to the method disclosed in Japanese Patent Laid-Open No. 2012-226489, and another publicly-known method may be used instead.

In step S207, the image processing unit 109 performs processing for generating a moving object region map.

FIG. 4 is a flowchart illustrating details of the moving object region map generation processing (step S207).

In step S401, the image processing unit 109 performs processing to reduce high-frequency components of the high-resolution image to bring the frequency band of the low-resolution image and the high-resolution image closer together. Specifically, the image processing unit 109 applies a filter (e.g., a low-pass filter or a band pass filter) to the high-resolution image that reduces the high-frequency components produced by the processing for generating the high-resolution image (the compositing processing on the plurality of low-resolution images). Although the specific frequency characteristics of the filter used here are not particularly limited, a filter having frequency characteristics determined through the following methods can be used, for example.

A first method is a method in which information indicating the frequency characteristics of a filter (filter information) that reduces the high-frequency components produced by the processing for generating a high-resolution image (super-resolution processing) is stored in the ROM 107 (recording medium) in advance. In this case, the image processing unit 109 reads out the filter information from the ROM 107, and determines, based on the read-out filter information, the frequency characteristics of the filter to be applied to the high-resolution image.

A second method determines the frequency characteristics of the filter, based on the positional relationships of the plurality of shooting positions corresponding to the plurality of low-resolution images to be composited. How much the frequency component will increase in the high-frequency band due to the super-resolution processing, when compared to the low-resolution image, can be predicted from the positional relationships of the plurality of shooting positions (in other words, the number of frames and the pixel shifting amount determined in step S201). Accordingly, the image processing unit 109 uses a filter having frequency characteristics that reduce (or cut) the frequency component in the high-frequency band that is predicted to increase.

A third method determines the frequency characteristics of the filter, based on the positional relationships of the plurality of shooting positions corresponding to the plurality of low-resolution images to be composited and the optical characteristics of the optical system 103 used to shoot the plurality of low-resolution images (optical data of the lens, such as MTF curves, the number of resolution lines, and the like). The limit on the frequency band of the high-frequency component increased by the super-resolution processing corresponds to the resolution performance of the lens of the optical system 103. Accordingly, the high-frequency band in which frequency components are produced by the super-resolution processing can be found more accurately based on both the positional relationships of the plurality of shooting positions and the optical characteristics of the optical system 103. The image processing unit 109 uses a filter having frequency characteristics that reduce (or cut) the frequency component in the high-frequency band, obtained in this manner.

A fourth method determines the frequency characteristics of the filter such that frequency bands lower than the Nyquist frequency of the plurality of low-resolution images are allowed to pass. The image processing unit 109 can obtain the Nyquist frequency of images captured by the image capturing unit 105 from the number of pixels in the image sensor and the optical characteristics of the optical system 103 (optical data of the lens, such as MTF curves, the number of resolution lines, and the like). The image processing unit 109 uses a filter having frequency characteristics that allow frequency bands lower than the Nyquist frequency, obtained in this manner, to pass.

Note that in step S401, the image processing unit 109 may apply a filter that reduces the high-frequency components produced by the super-resolution processing to any one low-resolution image among the plurality of low-resolution images in addition to the high-resolution image. This makes it possible to bring the frequency band of the low-resolution images and the high-resolution image closer together.

In step S402, the image processing unit 109 performs processing for obtaining the difference between the high-resolution image to which the filter has been applied in step S401 and any one low-resolution image among the plurality of low-resolution images. The “one low-resolution image” here refers, when the filter has been applied to a low-resolution image in step S401, to the low-resolution image to which the filter has been applied.

For example, the image processing unit 109 resizes (enlarges or reduces) at least one of the high-resolution image and the low-resolution image so as to make the high-resolution image and the low-resolution image the same size. The image processing unit 109 then generates a differential image by calculating (obtaining), on a pixel-by-pixel basis, the difference between the high-resolution image and the low-resolution image which have been made the same size.

Note that it is not necessary to make the high-resolution image and the low-resolution image the same size, and the image processing unit 109 may obtain the difference without performing the processing for resizing at least one of the high-resolution image and the low-resolution image. In this case, for example, the image processing unit 109 can generate a differential image by identifying the positions in the high-resolution image corresponding to the positions of the pixels in the low-resolution image and calculating (obtaining) the difference from the corresponding position for each pixel in the low-resolution image.

In step S403, the image processing unit 109 generates, based on the differential image obtained in step S402, a moving object region map. It is highly likely that a moving object is present in a region of the differential image where there is a large difference. Accordingly, for example, the image processing unit 109 determines whether the absolute value of each pixel value in the differential image is at least a threshold, and sets “1” in the corresponding position of the moving object region map for the pixel corresponding to the absolute value that is at least the threshold. Additionally, the image processing unit 109 sets “0” in the corresponding position of the moving object region map for pixels corresponding to an absolute value that is less than the threshold. This makes it possible to generate the moving object region map. Note that when generating the moving object region map, the image processing unit 109 may process the moving object region map such that the map is easy to use in processing in later stages, such as by performing threshold adjustment, gain adjustment, or the like taking into account band error and the like not absorbed by the filtering processing in step S401.

Returning to FIG. 2, in step S208, the image processing unit 109 corrects, based on the moving object region map generated in step S403, the moving object region of the high-resolution image generated in step S206. For example, the image processing unit 109 identifies, based on the moving object region map, the moving object region in the high-resolution image. The image processing unit 109 then replaces the identified moving object region with the corresponding region of any one of the plurality of low-resolution images generated in steps S202 to S205. Note that during the replacement, the image processing unit 109 enlarges the size of the corresponding region in the low-resolution image to match the size of the moving object region in the high-resolution image.

Note that when the size of the identified moving object region is greater than the threshold (e.g., when the ratio of the moving object region occupying the high-resolution image is greater than a predetermined ratio), the image processing unit 109 may replace the high-resolution image itself with an image obtained by enlarging one of the plurality of low-resolution images to the size of the high-resolution image.

In step S209, the image processing unit 109 saves the high-resolution image corrected (subjected to the replacement processing) in step S208. The storage destination may be, for example, the internal memory 111, a memory card, cloud storage, or the like. Note that as described above, in step S208, the high-resolution image itself may be replaced by an image obtained by enlarging one of the plurality of low-resolution images to the size of the high-resolution image. In this case, the image saved as a “high-resolution image” in step S209 is “the image obtained by enlarging one of the plurality of low-resolution images to the size of the high-resolution image”.

As described above, according to the present embodiment, the digital camera 100 obtains a plurality of shot images (the plurality of low-resolution images) shot at a plurality of shooting positions of the image sensor positioned such that a spacing between adjacent ones, in a first direction (e.g., the horizontal direction) or a second direction orthogonal to the first direction (e.g., the vertical direction), of the shooting positions is a non-integral multiple of the pixel pitch of the image sensor (½ the pixel pitch, in the example in FIG. 3) (steps S201 to S205). The digital camera 100 then generates a high-resolution image having a resolution higher than a resolution of the plurality of shot images by performing compositing processing on the plurality of shot images (step S206). The digital camera 100 also applies a filter to the high-resolution image that reduces the high-frequency components produced by the compositing processing (the processing for generating the high-resolution image) (step S401). The digital camera 100 then performs processing for obtaining a difference between the high-resolution image to which the filter has been applied and one shot image among the plurality of shot images (step S402).

In this manner, in the present embodiment, a filter that reduces the high-frequency components produced by the compositing processing (the processing for generating the high-resolution image) is applied to the high-resolution image. Applying this filter to the high-resolution image reduces the likelihood of a large difference arising between the high-resolution image and the original shot image (the low-resolution image) in a region where the moving object is not actually present. As such, according to the present embodiment, a highly-accurate difference that can be used to identify the moving object region in the high-resolution image can be obtained from the high-resolution image and the original shot image.

Although the foregoing described examples of methods for compensating for the image of a moving object region in the high-resolution image, other methods may be adopted as well. For example, a method that interpolates the image of the moving object region from images of regions around the moving object region in the high-resolution image may be used instead of the method that replaces the image with an image of the corresponding region in the low-resolution image.

Additionally, the result of detecting the moving object region may be used in processing aside from compensating for the image of the moving object region. For example, the result may be used in processing for notifying the user that a moving object region is present, processing for displaying an indication of the position of the moving object region, rating processing for determining an evaluation value according to whether a moving object region is present, or the like.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-015050, filed Feb. 2, 2024, which is hereby incorporated by reference herein in its entirety.

What is claimed is:

1. An image processing apparatus comprising at least one processor and/or at least one circuit which functions as:
a first obtaining unit configured to obtain a plurality of shot images shot at a plurality of shooting positions of an image sensor positioned such that a spacing between adjacent ones, in a first direction or a second direction orthogonal to the first direction, of the shooting positions is a non-integral multiple of a pixel pitch of the image sensor;
a generating unit configured to generate a high-resolution image having a resolution higher than a resolution of the plurality of shot images by performing compositing processing on the plurality of shot images;
a filter unit configured to apply, to the high-resolution image, a filter that reduces a high-frequency component produced by the compositing processing; and
a second obtaining unit configured to perform processing for obtaining a difference between the high-resolution image to which the filter has been applied and one shot image among the plurality of shot images.

2. The image processing apparatus according to claim 1, wherein the at least one processor and/or the at least one circuit further function as:
an identifying unit configured to identify, based on the difference, a moving object region in the high-resolution image; and
a replacing unit configured to replace the moving object region of the high-resolution image with a corresponding region of one of the plurality of shot images.

3. The image processing apparatus according to claim 2,
wherein when the moving object region is larger than a threshold, the replacing unit replaces the high-resolution image with an image obtained by enlarging one of the plurality of shot images to a size of the high-resolution image.

4. The image processing apparatus according to claim 1,
wherein the processing for obtaining the difference includes processing for resizing at least one of the high-resolution image to which the filter has been applied and the one shot image such that the high-resolution image to which the filter has been applied and the one shot image are of a same size.

5. The image processing apparatus according to claim 1,
wherein the filter unit reads out filter information indicating a frequency characteristic of the filter from a recording medium, and applies, based on the filter information, the filter to the high-resolution image.

6. The image processing apparatus according to claim 1,
wherein the filter has a frequency characteristic that is based on a positional relationship among the plurality of shooting positions.

7. The image processing apparatus according to claim 1,
wherein the filter has a frequency characteristic that is based on a positional relationship among the plurality of shooting positions and an optical characteristic of an optical system used to shoot the plurality of shot images.

8. The image processing apparatus according to claim 1,
wherein the filter has a frequency characteristic that allows a frequency band lower than a Nyquist frequency of the plurality of shot images to pass.

9. The image processing apparatus according to claim 1,
wherein the filter unit applies the filter to the one shot image, and
the second obtaining unit obtains, as the difference, a difference between the high-resolution image to which the filter has been applied and the one shot image to which the filter has been applied.

10. An image capturing apparatus comprising:
an image sensor; and
at least one processor and/or at least one circuit which functions as:
a first obtaining unit configured to obtain a plurality of shot images shot at a plurality of shooting positions of the image sensor positioned such that a spacing between adjacent ones, in a first direction or a second direction orthogonal to the first direction, of the shooting positions is a non-integral multiple of a pixel pitch of the image sensor;
a generating unit configured to generate a high-resolution image having a resolution higher than a resolution of the plurality of shot images by performing compositing processing on the plurality of shot images;
a filter unit configured to apply, to the high-resolution image, a filter that reduces a high-frequency component produced by the compositing processing; and
a second obtaining unit configured to perform processing for obtaining a difference between the high-resolution image to which the filter has been applied and one shot image among the plurality of shot images.

11. An image processing method executed by an image processing apparatus, comprising:
obtaining a plurality of shot images shot at a plurality of shooting positions of an image sensor positioned such that a spacing between adjacent ones, in a first direction or a second direction orthogonal to the first direction, of the shooting positions is a non-integral multiple of a pixel pitch of the image sensor;
generating a high-resolution image having a resolution higher than a resolution of the plurality of shot images by performing compositing processing on the plurality of shot images;
applying, to the high-resolution image, a filter that reduces a high-frequency component produced by the compositing processing; and
performing processing for obtaining a difference between the high-resolution image to which the filter has been applied and one shot image among the plurality of shot images.

12. The image processing method according to claim 11, further comprising:
identifying, based on the difference, a moving object region in the high-resolution image; and
replacing the moving object region of the high-resolution image with a corresponding region of one of the plurality of shot images.

13. The image processing method according to claim 12,
wherein when the moving object region is larger than a threshold, the replacing replaces the high-resolution image with an image obtained by enlarging one of the plurality of shot images to a size of the high-resolution image.

14. The image processing method according to claim 11,
wherein the processing for obtaining the difference includes processing for resizing at least one of the high-resolution image to which the filter has been applied and the one shot image such that the high-resolution image to which the filter has been applied and the one shot image are of a same size.

15. The image processing method according to claim 11,
wherein the filtering reads out filter information indicating a frequency characteristic of the filter from a recording medium, and applies, based on the filter information, the filter to the high-resolution image.

16. The image processing method according to claim 11,
wherein the filter has a frequency characteristic that is based on a positional relationship among the plurality of shooting positions.

17. The image processing method according to claim 11,
wherein the filter has a frequency characteristic that is based on a positional relationship among the plurality of shooting positions and an optical characteristic of an optical system used to shoot the plurality of shot images.

18. The image processing method according to claim 11,
wherein the filter has a frequency characteristic that allows a frequency band lower than a Nyquist frequency of the plurality of shot images to pass.

19. The image processing method according to claim 11,
wherein the filtering applies the filter to the one shot image, and
in the processing for obtaining, a difference between the high-resolution image to which the filter has been applied and the one shot image to which the filter has been applied is obtained as the difference.
